(19) United States
(12) Patent Application Publication
(10) Pub. No.: US 2012/0062021 A1
(43) Pub. Date: Mar. 15, 2012

(54) Wheel Lip

(75) Inventor: Paul Eric Lew, Las Vegas, NV (US)

(73) Assignee: REYNOLDS CYCLING LLC, West Jordan, UT (US)

(21) Appl. No.: 13/297,060

(22) Filed: Nov. 15, 2011

Related U.S. Application Data
(63) Continuation-in-part of application No. 12/909,559, filed on Oct. 21, 2010.
Application No. 12/909,559 is a continuation-in-part of application No. 12/455,393, filed on May 30, 2009, now abandoned.

(51) Int. Cl. B60B 5/02; B29C 41/22; B32B 37/00; B29D 22/00; B29C 70/30

(52) U.S. Cl. 301/95.103; 301/95.101; 301/95.104; 264/337; 264/573; 264/258

(57) ABSTRACT

A wheel rim comprising a lip formed on the wheel rim, the lip running parallel to the circumference of the rim. A method of forming a lip on a wheel rim, the method comprising: forming fiber layers on an upper and lower portion of a mold; forming fiber layers on an upper and lower portion of a mold; curing the fiber layers; removing the cured rim from the upper and lower portions of the mold; in which the internal surface of the lower portion of the mold comprises an indention that, once the fiber layers are cured, creates a lip on the surface of the rim.

### RELATED DOCUMENTS

The present application is a continuation-in-part, and claims the benefit under 35 U.S.C. §120, of U.S. application Ser. No. 12/909,559, entitled “Bead Seat Clincher” filed Oct. 21, 2010, which claims the benefit under 35 U.S.C. §120 of U.S. patent application Ser. No. 12/455,393, entitled “Wheel with Composite Rim” filed May 30, 2009. These applications are herein incorporated by reference in their entireties.

### BACKGROUND

With the advent of new materials available to the athlete, cycling has become a relatively more competitive sport. Because their physical strength and stamina may vary slightly, cyclists are looking to modern technology to help gain a competitive edge. Decreasing the aerodynamic drag of the equipment used is often a way to achieve that competitive edge. Another way is to better stabilize the rider and his or her bike so as to allow the athlete to focus more energy on propelling the bicycle forward rather than expelling energy in stabilizing it. Still further, modifying parts of the bicycle such as the wheels to reduce aerodynamic drag will also improve a cyclist's performance.

### BRIEF DESCRIPTION OF THE DRAWINGS

The accompanying drawings illustrate various examples of the principles described herein and are a part of the specification. The illustrated examples do not limit the scope of the claims.

FIG. 1 is a perspective view of a bicycle wheel according to one example of principles described herein.

FIG. 2 is a cross-sectional view of the rim of FIG. 1 according to one example of principles described herein.

FIG. 3A is a cross-sectional view of a portion of a rim showing a lip according to one example of principles described herein.

FIG. 3B is a cross-sectional view of a portion of a rim showing a lip according to another example of principles described herein.

FIG. 4 is cross-sectional view of a portion of a wheel showing the air flow over the wheel according to one example of principles described herein.

FIG. 5A and 5B are cross-sectional diagrams of a mold for a wheel and wheel lip according to one example of the principles described herein.

FIG. 6 is a flowchart showing a method of forming a lip on a rim of a wheel according to one example of principles described herein.

Throughout the drawings, identical reference numbers designate similar, but not necessarily identical, elements.

### DETAILED DESCRIPTION

As mentioned earlier, adjusting the shape of the wheel of a bicycle to reduce the aerodynamic drag of the wheel may result in improved performance of the bicycle and, therefore, a reduction in the travel time of the athlete.

Additionally, the wheel having the lowest overall weight will produce the lowest inertia and thereby will allow the cyclist to more easily accelerate. Because the wheel is constantly accelerating (changing direction, speeding up, or slowing down) a slight adjustment in the inertia characteristics of the wheel will be compounded over the entire length of the race which may result in precious seconds or even minuets of time lost in the race.

Therefore, the materials used to construct the wheels and alterations to the wheels to promote better aerodynamics are interrelated and affect the performance of the wheel. Adjusting these characteristics of the wheel correctly will produce a wheel that allows a cyclist to propel the bicycle through the air faster and easier.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

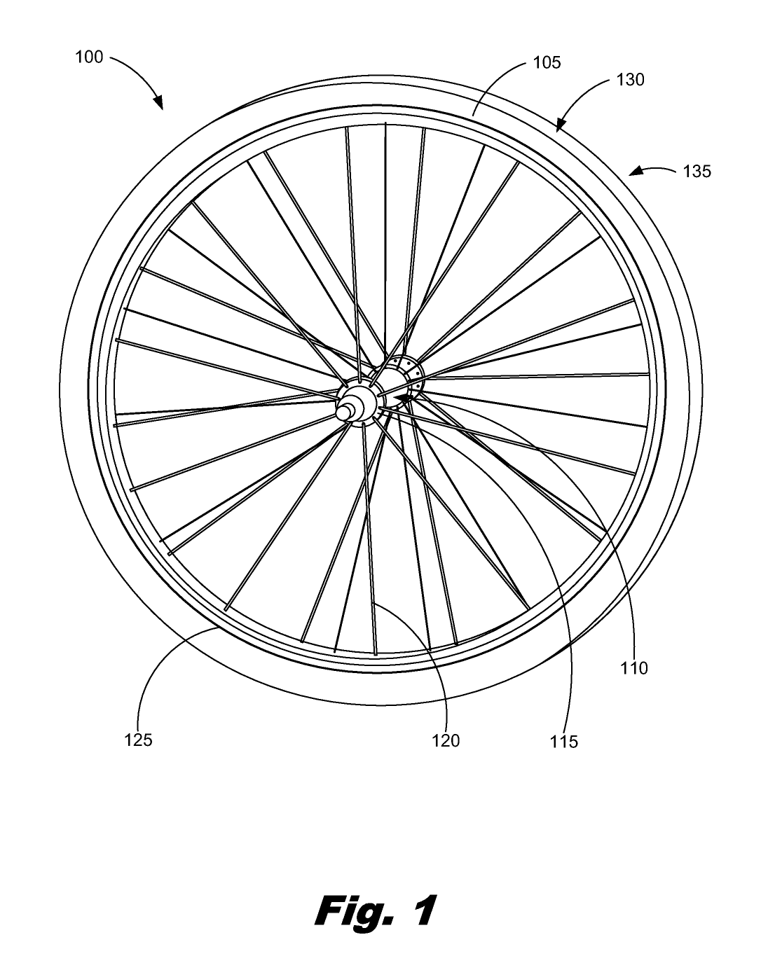

FIG. 1 is a perspective view of a bicycle wheel (100), according to one example of principles described herein. For simplicity in illustration, the wheel (100) in FIG. 1 is depicted without a tire located in the tire cavity (130). The wheel (100) comprises a rim (105), an axel (110), at least one hub (115), a number of spokes (120) coupling the rim (105) to the hub (115), and at least one lip (125) formed on the outer surface of the rim (105) and running parallel to the circumference of the rim (105) of the wheel (100). Each of these will now be described in more detail.

The rim (105) is made of sufficiently rigid material so as to support the weight of both the cyclist as well as the frame of the bicycle. In one example the rim (105) may be made out of a type of metal such as steel, aluminum, steel alloy, aluminum alloys, amongst others.

In other examples, the rim (105) may be made out of carbon fiber, boron fiber, glass fiber, or combinations of these. When using these types of fibers, sheets of the fiber material may be layered on each other. The various layers may be layered with the fibers of each layer running parallel, orthogonally, or intersecting with respect to other fibers in the other layers. The layers could then be placed in a mold and chemically bonded together using a resin adhesive. The resin may be allowed to cure over time or heat may be applied to thermally cure the resin. As a result, a rim (105) can be formed that is both light weight and structurally rigid to support the weight of both a rider and the bicycle frame.

The axel (110) of the wheel (100) is connected to the rim (105) via at least one hub (115) and a number of spokes (120). Although FIG. 1 depicts the use of three separate hubs as well as three corresponding sets of spokes (120), the wheel (100) may be comprised of any number of hubs (115) and spokes (120) to securely couple the axel (110) to the rim (105). However, as the number of hubs (115) increases, the number of spokes (120) may also increase. Consequently this may increase both the weight and drag of the wheel (100). Like the rim (105), the axel (110), the hubs (115), and the spokes (120) may be made of a metal, a metal alloy, a fiber such as carbon fiber, boron fiber, glass fiber, or combinations of these.

The spokes (120) may be coupled to the rim (105) via, for example, a number of nipples extending through holes defined along the interior surface of the rim (105). Each spoke (120) may then be secured to the rim (105) by tightening the nipple and engaging complementary threads on the nipple and spoke (120). In another example, the spoke (120) comprises a mushroomed head that, once the entire spoke (120) is passed through a hole defined in the rim (105), prevents the spoke (120) from falling through the hole. In this example, the spoke (120) may be tightened at the hub (115) in a similar way as that described above.

The hubs (115) may comprise a number of holes through which the spokes (120) may be coupled to the hub (115). Similar to the rim (105), the hub (115) may incorporate a number of nipples that the spoke (120) may engage with. Alternatively, the spoke (120) may comprise a mushroomed head that, once the entire spoke (120) is passed through a hole defined in the hub (15), prevents the spoke (120) from falling through the hole. The spoke (120) may then be coupled to the rim (105) in a way similar to that described above.

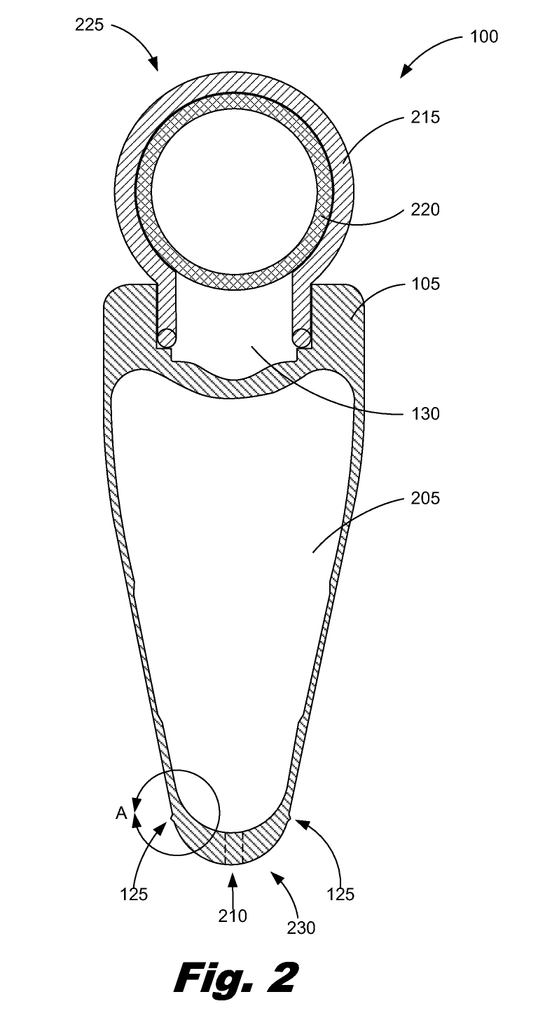

The rim (105) is also provided with at least one lip (125). In one example a lip (125) is located on either side of the rim (105) relatively close to the trailing or interior edge of the rim (105) and runs parallel to the circumference of the rim (105). In the examples shown in FIGS. 2, 4, 5A and 5B the rim (105) includes two lips (125) running parallel to the circumference of the rim (105). However, the present specification contemplates the use of any number of lips (125) defined on either side of the rim (105).

As will be discussed in more detail later, the lip (125) creates turbulence in the airflow moving over the rim (105) and reduces pressure drag on the rim (105). Additionally, the inclusion of the lip (125) may reduce the amount of materials needed to form the rim (105). As a consequence, the mass of the wheel can be reduced while still maintaining both the wheel's stability and mechanical durability.

FIG. 2 is a cross-sectional view of the rim (105) of FIG. 1 according to one example of principles described herein. As shown in FIG. 2, the wheel (100) additionally comprises a void (205) defined throughout the interior of the rim (105) running along the circumference of the rim (105) and a number of spoke holes (210) defined in the interior surface of the rim (105).

During the molding process, described above, a void (205) may be defined in the interior of the rim (105) running parallel to the circumference of the rim (105). In one example, the void (205) may be created by a bladder system inserted in the mold along with the layers of fibers described above. Before the resin is heated or otherwise cured, but after the mold has been sealed, the bladder may be inflated thereby forming the interior void during the curing process. This significantly reduces the amount of materials used in making the rim (105) and reduces the weight of the wheel. Consequently, this reduces the inertia of the wheel (100) which in turn reduces the power used by the cyclist to accelerate the bicycle forward.

The rim (105) may also include a number of spoke holes (210) formed along the interior side of the rim (105). As discussed above, these holes (210) allow for the insertion of a number of spokes (FIG. 1, 120). The spokes (FIG. 1, 120) may be fastened to the rim (105) via gluing, welding, riveting, or via a number of screws or a number of bolts and nuts, or other fasteners. In one example, a nipple may be passed through the hole (210) and engage with the spoke (FIG. 1, 120) via complementary threads located on the nipple and spoke (FIG. 1, 120).

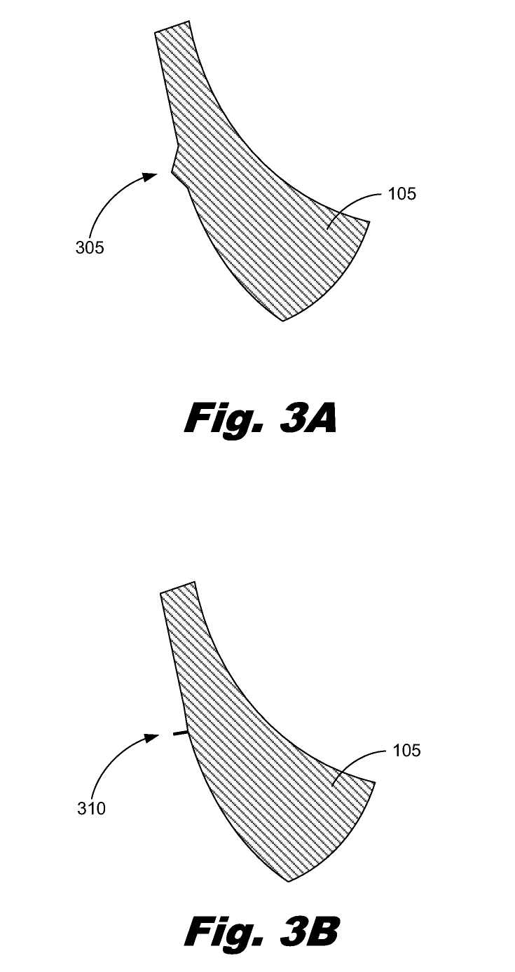

In addition to the above, the rim (105) comprises a number of lips (125) towards the trailing edge (230) of the rim (105). In one example, the rim (105) may comprise a lip on either side of the rim (105) as depicted in FIG. 2. In another example, the rim (105) may comprise one lip (125) on one side of the rim (105). FIGS. 3A and 3B are cross-sectional views of a portion of a rim (105) showing two separate examples of the lip (125) according to two examples of principles described herein.

FIG. 3A shows a section of the rim (105) indicated in FIG. 2 by circle A. FIG. 3A shows a lip (305) having generally an annular ridge that runs along the rim's (105) circumference. As will be discussed later, this lip (305) creates a turbulence in the airflow moving across the rim (105) thereby creating a vacuum that causes the airflow to follow the contour of the rim more closely (105). Reattachment of the air at the trailing edge of the rim (105) therefore occurs sooner. In addition, the lip (305) reduces the air turbulence and pressure drag generated on a low-pressure side of the rim (105) when cross winds are encountered. A reduction in the drag generated on a low-pressure side of the rim (105) results in a reduction in steering force used by the cyclist to keep the wheel (FIG. 1, 100) in line with the bicycle in a crosswind.

FIG. 3B shows a section of the rim (105) indicated in FIG. 2 by circle A. FIG. 3B shows a lip (310) consisting generally of an annular flange extending out from the outer surface of the rim (105). Much like the lip (305) shown in FIG. 3A, the lip (310) in FIG. 3B creates a turbulence in the airflow moving across the rim (105) thereby creating a vacuum that causes the airflow to follow the contour of the rim more closely (105). Consequently, this allows for less drag to be created by the wheel (FIG. 1, 100) and thereby decreases the amount of energy used to accelerate the wheel (FIG. 1, 100).

FIGS. 3A and 3B merely show examples of the shape and size of the lip (305, 310) that can be placed on the outer surface of the rim (105). The lip (305, 310) may, however, consist of various forms and sizes which may promote the airflow over the rim (105) to stay attached all the way to the trailing edge of the rim (105). Additionally, the lip (305, 310) may be placed any distance along the surface of the rim (105) to increase the aerodynamic efficiency of the wheel (FIG. 1, 100).

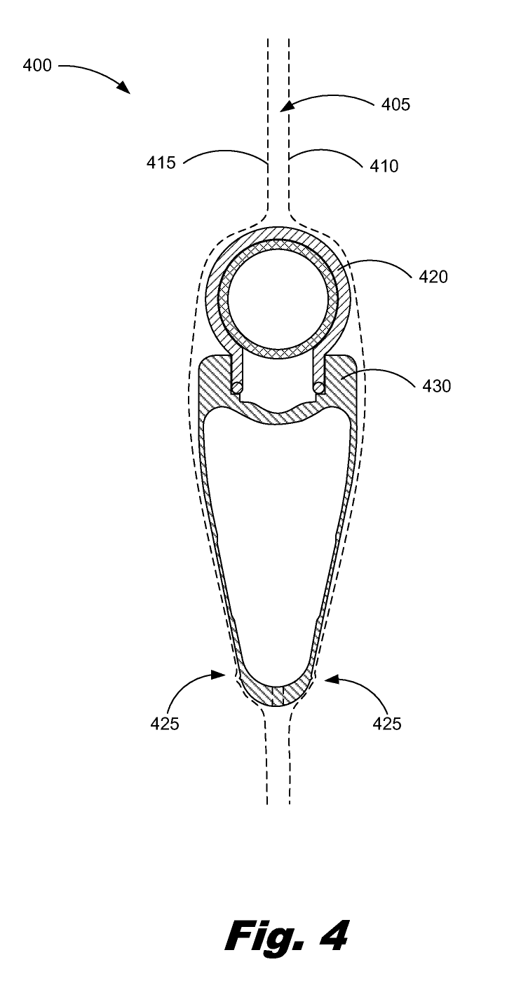

FIG. 4 shows how a decrease in the drag experienced by the wheel (FIG. 1, 100) may be accomplished. FIG. 4 is a cross-sectional view of a portion of the wheel (400) showing the airflow (405) over the wheel (400) according to one example of the principles described herein. As can be seen, airflow (405), depicted by the two dashed lines, splits into two sections (410, 415) as it contacts the tire (420). The two separated sections of airflow (410, 415) generally follow the outer surface of the wheel (400) as the wheel (400) progresses through the air. However, as the airflow sections (410, 415) get closer to the interior surface of the wheel (400), each of the airflow sections (410, 415) moves across a lip (425) that creates turbulence in the respective airflow (410, 415).

The turbulence creates a vacuum force directly behind the lip (425) that encourages the respective airflows (410, 415) to follow the contour of the rim (430). This causes the respective airflows (410, 415) moving over the rim (430) to reattach or combine again a distance that is relatively closer to the trailing edge of the rim (430) had there been no lips (425). Therefore, as a consequence of incorporating the lips (425) a smaller envelope of air or pressure drag is created along the trailing edge of the rim (430) than would have existed had the lips (425) not been incorporated into the rim (430). A mentioned above, the lip (425) also reduces the air turbulence and pressure drag generated on a low-pressure side of the rim (430) when cross winds are encountered. A reduction in the drag generated on a low-pressure side of the rim (430) results in a reduction in steering force used by the cyclist to keep the wheel (FIG. 1, 100) in line with the bicycle in a crosswind.

In addition to reducing drag along the trailing edge of the rim (430), the lips (425) may also reduce the amount of materials used in the construction of the rim (430). Reducing the amount of materials used reduces the weight of the rim (430) and thereby reduces the overall weight of the wheel (400). As discussed above, by reducing the weight of the wheel (400), less force may be employed by the cyclist to accelerate the wheel (400) through the air. This results in quicker acceleration and potentially a winning time for the cyclist.

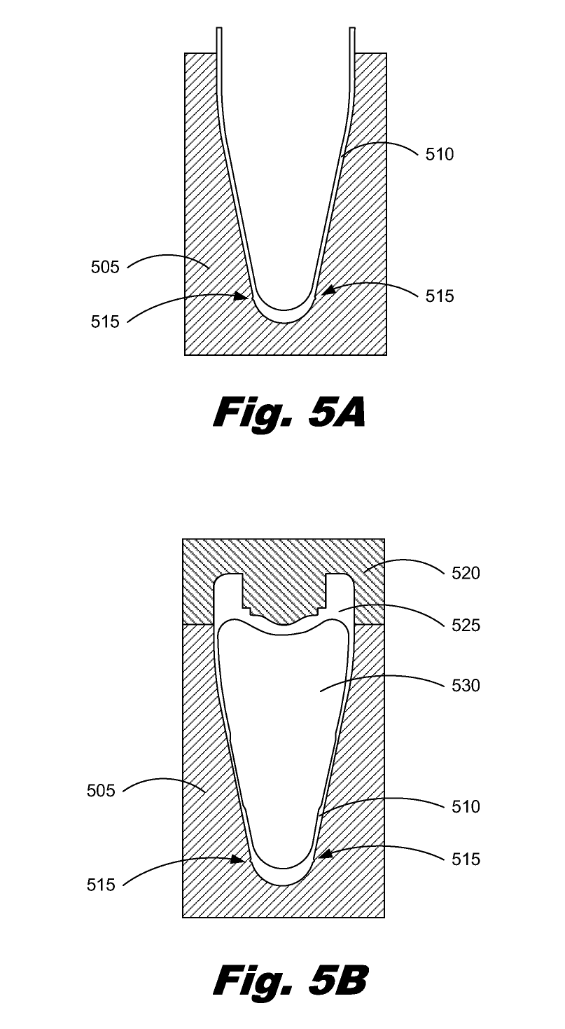

FIG. 5A is a cross-sectional diagram of a mold for a wheel and wheel lip (515) according to one example of the principles described herein. As described previously the rim (FIG. 1, 105) may be made of a number of materials such as carbon fiber, boron fiber, glass fiber, or combinations of these. Sheets of these materials may be layered within a lower mold (505) to create a lower section (510) of the rim (FIG. 1, 105). The sheets of these materials may have within them fibers which run parallel to each other.

In one example, therefore, the sheets may be layered one on top of another such that the fibers in each layer run parallel to each other. In other examples the fibers of the individual layers may run orthogonal to each other. In yet other examples, the fibers of the individual layers may run at various angles to each other. By altering the angles of the fibers in each layer with respect to each other, the mechanical strength of the rim (FIG. 1, 105) may be increased thereby allowing for more weight to be placed on the wheel (FIG. 1, 100). As previously mentioned, the lip (515) allows for less material to be used in the construction of the rim (FIG. 1, 105).

Each layer of fiber material may have a layer of resin placed between it and any subsequent layer. The resin will hold each layer together and may also add structural support to the rim (FIG. 1, 105).

Moving to FIG. 5B, an upper mold (520) may also be lined with layers of carbon fiber, boron fiber, glass fiber, or combinations of these thereby forming an upper section (525) of the rim (FIG. 1, 105). The upper mold (520) and upper section (525) may then be placed over the lower mold (505). In one example, a bladder (530) is inserted into the mold cavity above the lower section (FIG. 5A, 510) but below the upper section (525) of the rim (FIG. 1, 105). The bladder (530) may then be inflated after the upper (520) and lower FIG. 5A, 505) molds are coupled together. Once the bladder (530) has been inflated, the resin may be cured by, for example, applying heat to the molds (505, 520).

Once the resin has been cured, the molds (505, 520) may be separated and the bladder may be removed from the interior of the rim (FIG. 1, 105). As can be seen from FIGS. 5A and 5B, during the layering of the fiber sheets in the lower mold (505), a lip (515) is formed due to the internal surface of the mold. Specifically, the inner surface of the lower mold (505) may have an indention that is a mirror image of the lip (515). The indention, therefore, creates a lip (515) as described above. Additionally, the rim (FIG. 1, 105) and lips (515) are formed into a single piece. This avoids additional manufacturing steps that may otherwise be used to couple the lips (515) to the rim (FIG. 1, 105).

However, in another example, the rim (FIG. 1, 105) may be manufactured without the lips (515) added to the rim (FIG. 105). After curing of the rim (FIG. 1, 105) the lips (515) may be added to the surface of the rim (FIG. 1, 105) by, for example, layering additional sheets of fiber to the rim (FIG. 1, 105).

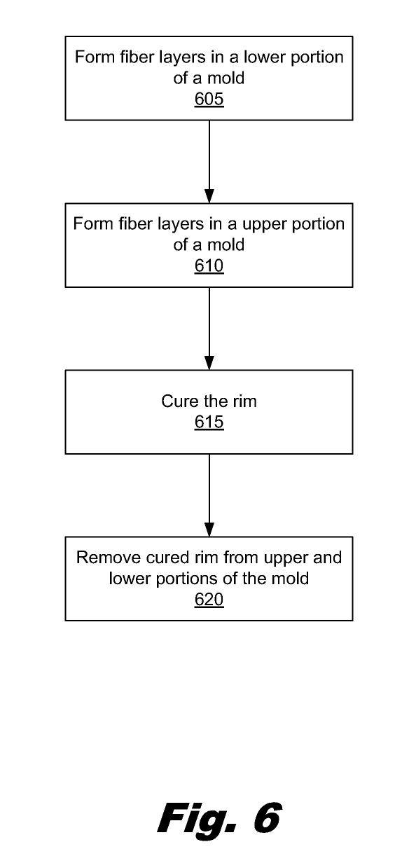

FIG. 6 is a flowchart showing a method of forming a lip on a rim of a wheel according to one example of principles described herein. The method includes forming (Block 605) fiber layers on the lower portion of a mold (505). As mentioned briefly above, these fibers may be in the form of sheets comprising carbon fibers, boron fibers, glass fibers, or combinations of these wherein the fibers of each sheet are running parallel respective to each other. These sheets may be layered with any number of layers of sheets forming the rim (FIG. 1, 105).

After the lower portion (FIG. 5A, 505) has been layered (Block 605) an upper portion (FIG. 5B, 520) of the mold may be layered (610) with the fibers. Again, these fibers may be in the form of sheets comprising carbon fibers, boron fibers, glass fibers, or combinations of these wherein the fibers of each sheet are running parallel respective to each other. These sheets may be layered with any number of layers of sheets forming the rim (FIG. 1, 105).

After the mold is closed, a bladder (FIG. 5, 530) may then be inflated to form a void within the mold cavity and specifically within the rim (FIG. 1, 105). After the bladder (FIG. 5, 530) has been inflated, the rim may be cured (Block 615). After the curing (Block 620) has completed, the bladder (FIG. 5, 530) may be deflated and the cured rim (FIG. 1, 105) may be removed (Block 620) from the upper and lower portions of the mold.

The specification and figures describe a wheel lip on the outer surface of a wheel. Specifically, the specification and figures describe a wheel rim comprising a lip formed on the wheel rim, the lip running parallel to the circumference of the rim. This wheel lip may have a number of advantages, including, but not limited to, reducing drag on the wheel, reducing the energy used by the cyclist to propel the wheel forward, and reducing the weight of the rim.

The preceding description has been presented to illustrate and describe examples of the principles described. This description is not intended to be exhaustive or to limit these principles to any precise form disclosed. Many modifications and variations are possible in light of the above teaching.

What is claimed is:

1. A wheel rim comprising a lip formed on the wheel rim, the lip running parallel to the circumference of the rim.

2. The wheel rim of claim 1, in which the wheel rim comprises carbon fiber.

3. The wheel rim of claim 1, in which the wheel rim comprises a number of sheets of carbon fiber, boron fiber, glass fiber or combinations thereof layered on top of each other.

4. The wheel rim of claim 1, in which the lip is a triangular ridge shape extending out from the exterior surface of the wheel rim.

5. The wheel rim of claim 1, in which the lip is an annular flange extending out from the exterior surface of the wheel rim.

6. The wheel rim of claim 1, in which the lip is configured to create turbulence in an airflow flowing over the rim and in which the turbulence forms a vacuum behind the lip that encourages the airflow to follow the contour of the rim.

7. The wheel rim of claim 1, in which the wheel rim is formed of one piece.

8. A wheel comprising:
a rim;
a lip formed on the rim, in which the lip runs parallel to the circumference of the rim.

9. The wheel of claim 8, in which the rim comprises carbon fiber.

10. The wheel rim of claim 8, in which the rim comprises a number of sheets of carbon fiber, boron fiber, glass fiber or combinations thereof layered on top of each other.

11. The wheel of claim 8, in which the lip is a triangular ridge shape extending out from the exterior surface of the rim.

12. The wheel of claim 8, in which the lip is an annular flange extending out from the exterior surface of the rim.

13. The wheel of claim 8, in which the lip is configured to create turbulence in an airflow flowing over the wheel and in which the turbulence forms a vacuum behind the lip that encourages the airflow to follow the contour of the rim.

14. The wheel of claim 8, in which the rim is formed of one piece.

15. A method of forming a lip on a wheel rim, the method comprising:
forming fiber layers on an upper and lower portion of a mold;
forming fiber layers on an upper and lower portion of a mold;
curing the fiber layers;
removing the cured rim from the upper and lower portions of the mold;
in which the internal surface of the lower portion of the mold comprises an indention that, once the fiber layers are cured, creates a lip on the surface of the rim.

16. The method of claim 15, in which a bladder is inserted into the middle of the mold in which the rim is cured with the bladder inflated, the bladder creating a void inside the cured rim.

17. The method of claim 15, in which the fiber layers comprise sheets of carbon fiber, boron fiber, glass fiber, or combinations of these.

18. The method of claim 15, in which the indention creates a lip that is an annular flange extending out from the exterior surface of the wheel rim.

19. The method of claim 15, in which the indention creates a lip that is a triangular ridge shape extending out from the exterior surface of the wheel rim.

20. The method of claim 15, in which the cured rim is formed of one piece.
